(19) United States
(12) Patent Application Publication
(10) Pub. No.: US 2014/0162771 A1
(43) Pub. Date: Jun. 12, 2014

(54) Betting Game Based on Past-Time Bet Information for the Game

(71) Applicant: Sergei Kurdimov, Fort Lee, NJ (US)

(72) Inventor: Sergei Kurdimov, Fort Lee, NJ (US)

(21) Appl. No.: 13/712,464

(22) Filed: Dec. 12, 2012

(51) Int. Cl. G07F 17/32

(52) U.S. Cl. CPC G07F 17/3288
USPC 463/28

(57) ABSTRACT

A betting game is disclosed where betting amounts for tokens are shown to opponents at regular intervals; however, at each regular interval, the betting amount is shown for a previous time. During the game, players bid based on what they think other players will do, but only have lagged (prior time) betting information at any moment during the game, until the game ends. Once the game ends, players are paid out a percentage based on the placement of their tokens. Side bets by non-players may also be made which do not affect the placement of the tokens or pay-out to the players, the side bets having a pay-out based on a win/loss percentage forecast. The house (game administrator) may contribute to the winning pot or take a percentage of the winnings as a fee. Further, in some embodiments, players may enter more than one token, sometimes for an additional fee to be paid to the house or into the pot to be paid out.

### FIELD OF THE DISCLOSED TECHNOLOGY

The disclosed technology relates generally to betting games, and, more specifically, to a betting game based on the total amount betted, with bet information provided only at intervals.

### BACKGROUND OF THE DISCLOSED TECHNOLOGY

Betting games are, of course, known in the art. In such games, one usually bets on the outcome of an unknown variable. In horse racing, one bets on which horse will come in first, second, or third place. In poker, one bets on who has the best five-card hand. In stock investments, one bets on whether a stock price will increase over the course of the investment. In each of these cases, some information is known, while other information is unknown, which determines the risk involved. In each of these cases, information about prior history is known, as well as current fundamentals of the thing being bet on. For horses, this involves the health, breed, and win/loss history of a particular horse, as well as of competing horses. In poker, some cards (of the opponent or shared by all players) may be showing, and the bets and facial expressions of the other players come into play. Every player knows what is in his hand, and how many cards opponents have picked up, and can thus make educated guesses as to whether an opponent is “bluffing” and as to the relative strength of the opponent's hand compared to one's own. With stocks, the fundamentals about the company considered for investment in include its financial information, evaluation of the company's products, and past stock history.

In each of the above cases, one is betting (defined as placing money at risk of loss) based on the outcome of an event, whether it be the outcome of cards held, a race, or future valuation/income target for a company. That is, the bet is tied, directly or indirectly, to a measurable and determinate future outcome. This, in short, is the excitement of betting—the expectation of winning or losing based on the prediction being correct or incorrect. The amount one can win is usually close to the odds of winning, minus a transaction cost paid to a casino, broker, or other entity to cover the costs (and make a profit) off such games. Such a transaction fee may be a cost of entry into the game, fixed cost for each transaction, and/or percentage of the total pot bet or winnings.

Recent patents and patent applications on the subject of enhancing the betting experience are found in the following sampling of documents. U.S. Pat. No. 6,120,376 assigned to Horse Sense Corporation discloses a wagering game with many participants. Players wager on a specific game, and a ranking order of the game participants is determined in a race to a finishing point. The sum of the identification numbers of a subset of the game participants is calculated, and the number of lengths by which a first game participant beats another game participant to a finishing point can also be calculated. This concept allows one to bet money and rank players.

U.S. Patent Publication 2009/0233716 to Cash discloses a method of allowing poker players to receive funding from investors through an on-line website. The investment may be all, or a percentage, of the buy-in and dictates how much of a winning amount the investor may receive.

U.S. Pat. No. 5,374,060 assigned to Total Communication Programs, Inc. discloses a wagering method for betting on races where one can bet on winning, placing, or showing (1′, 2′, or 3′ place) and combinations thereof, with payouts based on betting on the right combination of same. The payout is a predetermined prize commensurate with the probability of the correct selection.

Betting, for purposes of this disclosure, covers a placement of money where one may gain or lose the investment. This includes betting on games for entertainment purposes and investing by placing one's money with another to use to earn, or potentially lose, the money. Given the pervasive nature of monetary investment/betting, with some instances with more sound (predictable) fundamentals than others, there is a continued desire for advancement and new methods of betting.

### SUMMARY OF THE DISCLOSED TECHNOLOGY

Embodiments of the disclosed technology are for betting games involving betting on totems, markers, or other tangible items with some sort of differentiator from others, allowing it to be recognized as belonging to a particular player. The differentiator may be its placement or indicium written thereon. At the start of a game, a timer (any timing device) begins to run with a designated time until the end of the game. Bets are received from each player for each of their tangible items entered into the game. The bets may be of a fixed dollar amount per bet, have a minimum and maximum bet, and may be placed whenever the player desires, or only once over any period of time. A receiving mechanism receives such bets while the timer is running and the game is being played. A display device exhibits the total received bets for each item at regular time intervals (such as every 30 seconds, 1 minute, or 5 minutes) but the exhibited total for each item is for a previous time during the game (such as 10 s, 20 s, 30 s, or 1 minute before a regular time interval is reached, where ‘s’ is an abbreviation for ‘seconds’). That is, the players are only made aware of and know what each prior player has betted based on outdated data/non-realtime/past data. Such past data are defined as betting amount totals from a time before players could have placed another bet and may be 1 s, 5 s, 10 s, 30 s, or 1 minute before the time of display of the betting totals. These past data may be a fixed amount of time prior to a time when said display device is updated at each regular time interval of said regular time intervals.

At the end of a game, in embodiments of the disclosed technology, items are ranked by total placed bets on each item, and pay-outs are made to players of the game based on placement order of each tangible item of the plurality of tangible items. Pay-outs are made, for example, for first and second places, or first, second, and third places. In order to make the game challenging, pay-outs are such that a winner of first place, who wins by too much, will actually lose money. For example, pay-outs may be 50% of the pot for first place, 30% for second place, and 20% for third place. Payouts may also vary, based on a predetermined formula whereby the pot is divided amongst the winners based on the closeness of the bets received. Thus, one wants to beat an opponent, but not by too much, and when viewing only past-time betting amounts, this presents the emotional, logical, and psychological challenge of the game. Further, the pay-out may be increased by a starting bet, or by an initial pot provided by an administrator of the betting game. Such an administrator may also take a cut of the winnings at the end, diminishing the percentage won by the players who had placed.

In embodiments of the disclosed technology, a player can place more than one tangible item into the game for betting, and place bets on one or more of his items entered into the game. In some games, each player has a minimum number of items in play, such as two or three, and can add a tangible item into the game in mid-game, such as for a financial cost or penalty to the other bets already placed. A bet may then be received for each item entered into the game.

Further, bets may be placed by those who are not the main players in the game. Such bettors are people who are unassociated with any of the tangible items in the game, or at least are unassociated with the tangible item for which a side bet is being place on. That is, a bet in the main game, which determines placement of the tangible item may only be placed by the player associated with such an item, however, in embodiments of the disclosed technology, anyone may place a side bet (a bet not effecting the placement of the tangible items) on items which are not their own. They may place side bets on such items and are paid out, at the end of the game, a percentage or an amount based on the placement of the item. Their bet does not affect placement, however, as only a bet from the player associated with or owning the item entered into play determines its associated value for the purposes of the item winning, placing, or showing, at the end of the game, in embodiments of the disclosed technology.

In a method of the disclosed technology, the method is carried out by way of the following steps. First, a plurality of tangible items for betting on in the betting game is designated. Each item of the plurality of tangible items is associated with a player of the betting game. A timer is started and runs for the duration of the game, being displayed to the players. The timer stops at the end of the game. While the timer is running (during the game), via a receiving device, a game administrator (person or computer device) receives at least one bet for each item. A display device exhibits total received bets for each item at regular time intervals while the timer is running, but the exhibited total received bets for each item are from a previous time during the betting game. Pay-outs are made based on a percentage of the total bets (modified by any one of a starting amount provided by the game administrator, entry fee, and fee to the house/administrator, if any) depending on placement of each item, with the player associated with the respective item receiving the pay-out. Other features, described above with respect to the device of the disclosed technology, are also applicable for use with the method of the disclosed technology.

### BRIEF DESCRIPTION OF THE DRAWINGS

FIG. 1 shows steps taken to carry out a method of playing a betting game of embodiments of the disclosed technology.

FIG. 2 shows a high level block diagram of devices used to carry out embodiments of the disclosed technology.

FIG. 3 shows a table of data from an actual game.

FIG. 4 shows a high-level block diagram of a device that may be used to carry out the disclosed technology.

### DETAILED DESCRIPTION OF EMBODIMENTS OF THE DISCLOSED TECHNOLOGY

A betting game is disclosed where betting amounts for tokens are shown to opponents at regular intervals; however, at each regular interval, the betting amount is shown for a previous time. During the game, players bid based on what they think other players will do, but only have lagged (prior time) betting information at any moment during the game, until the game ends. Once the game ends, players are paid out a percentage based on the placement of their tokens. Side bets by non-players may also be made which do not affect the placement of the tokens or pay-out to the players, the side bets having a pay-out based on a win/loss percentage forecast. The house (game administrator) may contribute to the winning pot or take a percentage of the winnings as a fee. Further, in some embodiments, players may enter more than one token, sometimes for an additional fee to be paid to the house or into the pot to be paid out.

The term “real-time” or “near zero” refers to an instantaneous or interactive process (as opposed to a process which occurs relatively slowly, in a “batch” or non-interactive manner).

The term “past-time” or “lag” refers to a process involving purposeful wait time between an event and a display of data about the event.

Embodiments of the disclosed technology will become clearer, in view of the following description of the figures.

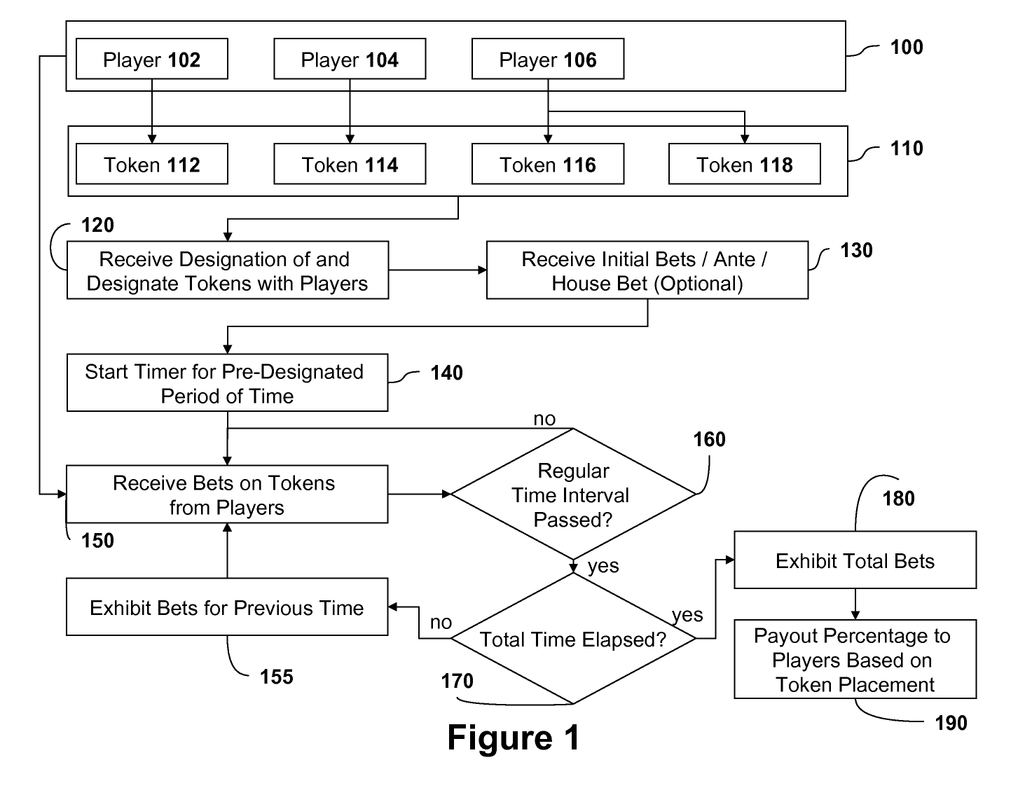

FIG. 1 shows steps taken to carry out a method of playing a betting game of embodiments of the disclosed technology. Each player 100, such as players 102, 104, and 106 designated a token 110, such as specific tokens 112, 114, 116, and 118 to be used to play the betting game. These tokens may be any tangible object with a differentiator from others, allowing it to be recognized as belonging to a particular player. The tangible object may also be an electronic representation made tangible by its display on a video screen. That is, certain pixels of the video screen are the tangible object, with a representation or indicia used as the token. The tokens are associated with particular players. In the example shown in FIG. 1, player 102 enters token 112 into the game, player 104 enters token 114 into the game, and player 106 enters tokens 116 and 118 into the game. Depending on the embodiment, a player may enter one, two, three, or more tokens into a game. Each player may be given the choice to pay for more tokens to be entered, at the beginning. In step 120, the designation of the tokens is received and the designation, by a game administrator, is made as to which player is associated with which token. The token-to-player designation may be made entirely by the game administrator, in one embodiment.

Once the players 100 are associated with their tokens 110, in step 120, the game may begin. In an optional step 130, initial bets are made, which may include a house bet. A house bet is an initial amount of money entered into the game by a game administrator. In step 140, a timer is started and will run for a pre-designated period of time, such as 1 minute, 5 minutes, 10 minutes, 30 minutes, 1 hour, 3 hours, and so forth. Once the clock is running and the game has begun, players bet on their tokens. Such bets are received in step 150. After a regular interval of time, which is a fraction of the length of the game (length that the timer runs), a regular time interval has passed. A regular time interval, for purposes of this disclosure, is defined as a plurality of pre-defined times during an active game (from the time the timer starts running until it stops, and the game is over). These times may be equi-distantly spaced in time from one another and are a subset of the total time of the game. As such, there may be two, three, four, four, five, six, eight, ten, twelve, fifteen, or even twenty or twenty-five regular time intervals within a game. For example, in a one minute game, the regular time intervals may be every 10 seconds; in a five minute game, the regular time intervals may be every 30 seconds or every minute, and in a 30 minute game, the time intervals may be every five minutes. In the longer games, one can watch motions of one's opponents, in embodiments, to determine if perhaps they are making bets on their tangible objects.

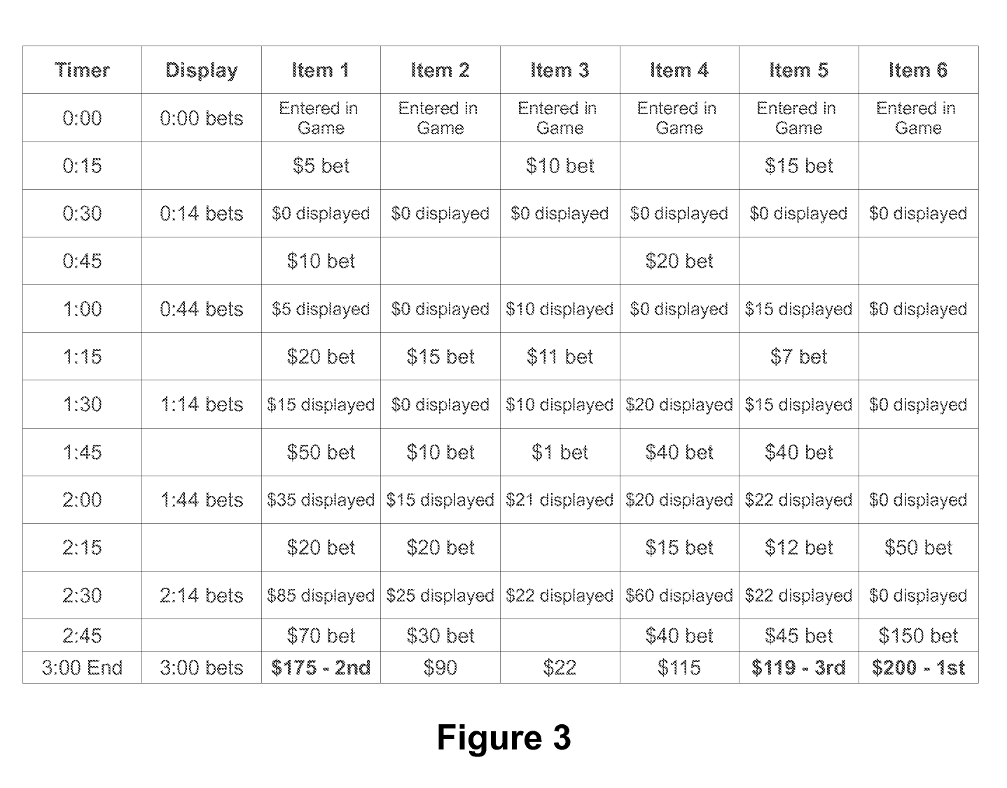

Referring again to FIG. 1, if the total time has elapsed, in step 170, then the game is over. Before delving into the steps when the game is over, in step 155, at regular time intervals when the game is still in process, bets are exhibited for a previous time period. As such, it becomes a strategy to try and “hide” your bets from other players by placing your bets close to the time interval. To make it more interesting, in embodiments, the time is not displayed to the players, and the time interval between the exhibited bets of a previous time and the present time may be pseudo-random and may increase or decrease during the game. For example, in a 5-minute game where the regular time intervals (see step 160) are every 30 seconds, in step 155, the exhibited bets for a previous time (see step 155) may be 5 seconds, 10 seconds, or even 30 seconds (the full regular time interval) before the present time. In FIG. 3, which shows an example of data from an actual game, this will become clearer. After exhibiting the passed-time bets (total bets for each tangible item at a prior time before the present), steps 150, 160, 170, and 155 are repeated, accepting new bets until the total time elapsed for the game expires, in step 170.

Once the total time for the game elapses, the total bets, at the end of the game, are exhibited in step 180. Then, in step 190 a pay-out percentage to the players is made based on the placement of their token (tangible item). For example, the pay-out may be 50% of the pot (total bets+initial bets by the house—percentage pay-out to the house) for first place, 30% for second place, and 20% for third place. So in a simple example, where token 112 receives $500, token 114 receives $200, token 116 receives $5, and token 118 receives $0, and there is no house (game administrator) pay-in or pay-out involved, then player 102 receives $352.50 ($705 total*50%), player 114 receives $211.50 ($705 total*30%) and player 106 receives $141.00 ($705 total*20%). As such, the player in first would actually “lose,” while the second and third place players would “win” by earning more money. If the values were changed as follows: token 112→$200, token 114→$175, token 116→$150, and token 118→$25, then the results would turn out very differently. In this example, player 102, who is associated with token 112, only gets first place and earns $275; player 104, who is associated only with token 114, earns $165; and player 106, who is associated with tokens 116 and 118, earns $110. In this example, where the bets are more even, the person who is in first place does, in fact, gain more money then entered into the game, while the person in second place and the person in third place lose money. Had player 104 beaten player 102 by betting another $26, then player 104 would win the most money. The key to success in the game is to be either in first place by a little bit, or in the lower places by a large difference. Payouts may also vary, based on a predetermined formula whereby the pot is divided amongst the winners based on the closeness of the bets received.

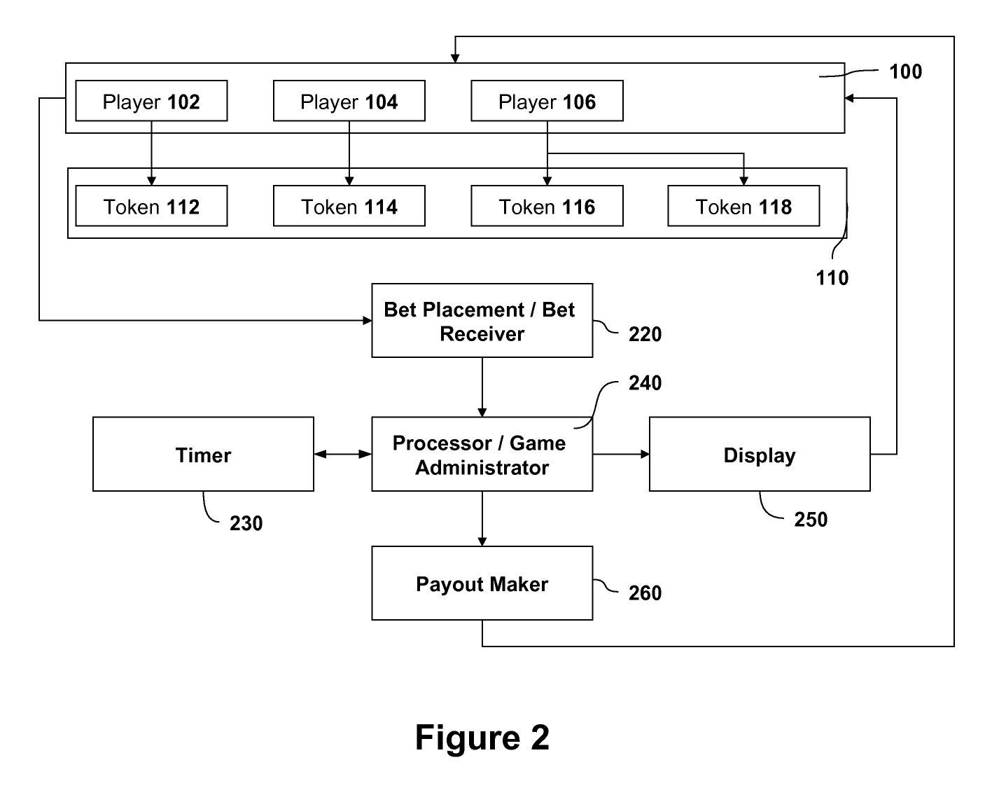

FIG. 2 shows a high level block diagram of devices used to carry out embodiments of the disclosed technology. Events 100 through 118 remain as described with respect to FIG. 1, though it is again emphasized that any number of players and any number of tokens (tangible objects) may be used in a game. Each player 102, 104, and 106 is associated with one or more tokens 112, 114, 116, and 118. The processor or game administrator 240 runs the game. The processor is a hardware device within a computer system which carries out the instructions of a computer program by performing basic arithmetical, logical, and input/output operations on a system. The processor may act as the game administrator, work together with a human game administrator, or the game may be conducted by a human game administrator in its entirety without the aid of a computer processor. The processor or game administrator 240 interacts with the players 100 directly, and places bets for tokens 110 directly, and/or by way of a bet placement mechanism 220 where the bets are received.

This bet placement mechanism may be a physical location where betting chips or currency are placed, or an electronic receiver such as a button connected to electronic circuitry indicating that a bet is being made by a player 100 for a token 110. The bets placed and received are unknown to the other players, or, at least partially hidden from the other players. (“Partially hidden” is defined as the precise betting amount being unknown, but the fact that a bet was made being known, such as by seeing movement by another player or receiving a direct indicator thereof). A timer 230 is started by the processor/game administrator at the beginning of the game, the time being shown to the players during the game, and at regular time intervals, when it is time to exhibit bets made on a display device 250, the display shows bets made on a past-time basis (a time prior to the present regular time interval). As such, players see on the display 250 the total bets for each token 110, but not in real-time. The display device 250 may be an electronic display, such as an LCD (liquid crystal display) or other video screen; a chalk board with chalk markings for the passed-time totals; an auditory call-out, or the like; and the display, as well as the players, may be spaced apart, communicating via the Internet from, for example, more than 10 miles away each, or all at the same physical location (within the same building or area of contiguous land ownership).

When the game is over, the timer 230 reaches a certain time which indicates the end of the game (such as by displaying “0:00” or “20:00” to indicate 0 seconds remaining, or that 20 minutes of the game have passed; the first number is minutes, and the number after the colon represents seconds). At this time, the processor/game administrator interacts with the pay-out maker 260 to effectuate pay-out for the winning players of the players 100. Such a pay-out maker may be a person physically handing cash or playing chips to each player next to their respective tokens 110, a computerized or electronic system depositing funds on a playing card or into an account associated with a respective player, or the like. The payout maker 260 may be integrated with, or the same as, the processor/game administrator 240 or may be a separate entity receiving instructions from the processor/game administrator 240.

FIG. 3 shows a table of data from an actual game. In the first column is the “Timer”—the time of the game from start to finish (see steps 140 and 170 of FIG. 1). In this game, the time starts at zero and runs for three minutes (“3:00” designates 3 minutes and zero seconds, by way of example). The “Display” column indicates what is displayed to the players, for example, on the display device 250 described with reference to FIG. 2. The entries in this column are from the time during the game that the total bets are displayed. For example, at one minute (“1:00”) the bets as of 16 seconds prior, at 44 seconds (“0:44”) are displayed. Thus, in this game, bets are always displayed on a 16-second lag from actual time, updated at 30 second increments (see steps 160 and 155 of FIG. 3). In an embodiment, the bets are updated on the display with ever greater frequency to add excitement, and/or with a decreasing lag time. The items 1, 2, 3, 4, 5, and 6 are tangible items or tokens entered into the game, which may represent one from each of six players (see 100 and 110 of FIG. 1), two from each of three players, or any other variation, such that each token is associated with at least one player (for example, tokens 1-5 could be from a first player, while token 6 could be from a second player).

Moving into the actual game being played, as shown in FIG. 3, at zero seconds, at the start of the game, items 1 through 6 are entered into the game. For simplicity, while players may place bets (see step 150 of FIG. 1) at any time, in embodiments of the disclosed technology, the betting time has been limited to 30-second increments starting at the 15-second mark. Alternatively, the bets shown may be seen as the total number of bets between updates of the display. Players may wish to make multiple bets between updates for psychological reasons—it will make their opponent believe that they are betting a lot, or otherwise induce other players to bet more or scare them into quitting. At 15 seconds, items 1, 3, and 5 receive their first bets, as shown. At 45 seconds, items 1 and 4 receive a bet. The players, as shown, start timidly with relatively small bets because, if a player bets a lot of money at the outset, he can easily be outwitted by other players betting relatively smaller amounts, causing the player vastly ahead to lose out in the end.

At 30 seconds, the display was first updated, but since the bets are being shown on a 16-second lag, and the first bet was at 15 seconds, the display simply updates by showing $0 betted for each item (or need not actually change the display at all). At one minute, the display is updated with the past-time bets as of 44 seconds into the game. Thus, the display shows $5 betted for item 1, though in reality at this time, item 1 has $15 of bets. Here, at the one minute mark, it appears, based on the display, that item 5 is in the lead with $15, but actually, item 4 is in the lead with $20. The player associated with item 4 will know that his item has a real present bet of $20, though he won't know that item 5 really has a present value of $22; thus, item 5 actually is in the lead! The confusion and psychology of betting make the game lively, fun, and interesting, while removing the other aspects of chance in games for which betting, such as during card games or horse racing, requires.

Jumping now to the 2:30 mark on the clock, the displayed bets are as of 2:14. Here, the top three items, based on what's displayed, are Item 1, Item 4, and Item 2. In reality, this is actually not true. Item 6 has received its first bet at 2:15, which is not shown at 2:30. Thus, Item 6 actually has a $50 bet. No bet on Item 6 is ever shown, in this game, until the end of the game. It might be assumed that the player associated with Item 6 simply is not playing Item 6 or will gamble with a single bet at the end, as he does. Thus, one must bet on one's item having in mind what the owner of item 6 will do. If the player of item 6 is also, for example, the player of item 5, then this must be taken into account, because the psychology of the player is of great significance.

At the end of the game (see steps 170 and 180 of FIG. 1), once all bets are in, the final bet totals are displayed and a payout is made (see step 190 of FIG. 1). At the three minute mark, at the end of the game, it is seen that Item 6 comes in first place with a $200 bet. Item 1 comes in second place with a $175 bet, and Item 5 comes in third place with a total of a $119 bet. The bet total for the entire game is $721. In a game with a 50:30:20 split for first, second, and third place, the player of Item 6 receives $360.50, the player of Item 1 receives $216.30, and the player of Item 5 receives $144.20.

Determining if one has made or lost money in the game depends on which items were which player's. For example, if a single player played Items 1 and 2, another player played Items 3 and 4, and yet another player played Items 5 and 6, then the player of Items 3 and 4 lost his entire $137 bet, while the owner of Items 1 and 2 also lost money. The owner of Items 5 and 6 is the big winner in such a game, raking in $360.50 based on an outlay of $195.00.

If the owners were different, than the winners and losers would change. For example, suppose each item is played individually by a different one of six players. Here, obviously, the players of Items 2, 3, and 4 lost out entirely. However, each of the winning players for Items 1, 5, and 6 makes money (Item 1: $175→$216.30; Item 5: $119→$144.20; Item 6: $200→$360.50). Thus, the number of players and number of items played, as well as their associated bets, all affect who gains or loses money in a game.

Other eventualities include required minimum bets, required minimum opening bets, starting pot which contributes to the pay-out (see step 130 of FIG. 1), required ante to enter the game, required ante for additional items to be entered into the game by the same player or group of players working together (for example, Item 1 and Item 2 may be played by different individuals with their own fiscal responsibility for their respective item, but may share their bets with each other), and a portion of winnings going to the house (game administrator).

Further, it should be understood that, in embodiments of the disclosed technology, side bets may be made on tokens/tangible items which are not associated with a player. A side bet is a bet made by a person, or as a bet designated as separate from the pot and bets made by each player who is associated with each item. That is, a player enters a token/tangible item into the game and is associated with that item. Depending on placement of that item, the player receives a pay-out. A side bet, or bet by a person unassociated with a particular item, does not affect pay-out or add to the pool of money paid out to those players based on the items they are associated with. Side bets are paid out as is known in horse racing, with a designated win:loss ratio and payout ratio. Thus, if a person, for example, bets on token 114 as coming in first, second, or third place, and the bet and/or person is unassociated with a bet which is part of the main game between player 104 and token 114 (see FIG. 1), then they are paid out accordingly, such as 10:1 for first place, 4:1 for second place, and 2:1 for third place. The pay-out ratio may change as the game progresses. For purposes of making a pay-out to players based on the total bets, the bets made by a person unassociated with an item he/she is betting on is uncounted and in a separate pay-out calculation from the unassociated bets.

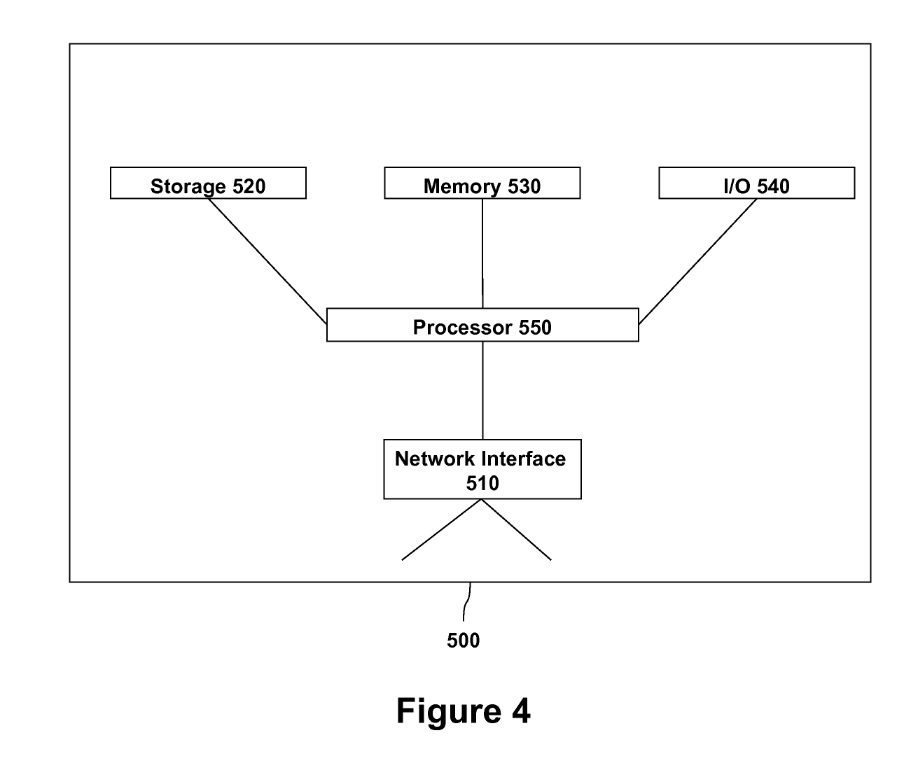

FIG. 4 shows a high-level block diagram of a device that may be used to carry out the disclosed technology. Device 500 comprises a processor 550 that controls the overall operation of the computer by executing the device's program instructions which define such operation. The device's program instructions may be stored in a storage device 520 (e.g., magnetic disk, database) and loaded into memory 530 when execution of the console's program instructions is desired. Thus, the device's operation will be defined by the device's program instructions stored in memory 530 and/or storage 520, and the console will be controlled by processor 550 executing the console's program instructions. A device 500 also includes one or a plurality of input network interfaces for communicating with other devices via a network (e.g., the Internet). The device 500 further includes an electrical input interface. A device 500 also includes one or more output network interfaces 510 for communicating with other devices. Device 500 also includes input/output 540 representing devices which allow for user interaction with a computer (e.g., display, keyboard, mouse, speakers, buttons, etc.). One skilled in the art will recognize that an implementation of an actual device will contain other components as well, and that FIG. 5 is a high level representation of some of the components of such a device for illustrative purposes. It should also be understood by one skilled in the art that the method and devices depicted in FIGS. 1 through 3 may be implemented on a device such as is shown in FIG. 4.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. A betting game, comprising:
a plurality of tangible items, each item of said plurality of tangible items associated with a player of said betting game;
a timer running from the start of said game to an end of said game;
a bet-receiving mechanism receiving at least one bet for each item while said timer is running;
a display device exhibiting total received bets for each item at regular time intervals while said timer is running, said exhibited total received bets for each item being for a previous time during said game.

2. The betting game of claim 1, wherein said previous time is a fixed amount of time prior to a time when said display device is updated at each regular time interval of said regular time intervals.

3. The betting game of claim 1, wherein more than one tangible item is associated with said player of said betting game. and said bet receiving mechanism receives at least one bet for each said more than one tangible item.

4. The betting game of claim 2, wherein at the end of the game, items are ranked by the total number of placed bets on each items, and pay-outs are made to players of said game based on placement order of each tangible item of said plurality of tangible items, wherein pay-outs are made for at least first and second place.

5. The betting game of claim 4, wherein the total number of placed bets further comprises a starting amount paid by an administrator of said betting game before said start of said game.

6. The betting game of claim 4, wherein said pay-out is diminished by a percentage retained by an administrator of said betting game after said end of said game.

7. The betting game of claim 4, wherein pay-out percentages are designed such that a player winning first place loses money when betting a threshold amount over a player winning second place.

8. The betting game of claim 7, wherein said first place pay-out is 50% of said total placed bets, said second place pay-out is 30% of said total placed bets, and said third place pay-out is 20% of said total placed bets.

9. The betting game of claim 1, wherein said bet-receiving mechanism receives a bet for a said tangible item of said plurality of items from a person unassociated with said item, and a payout is made to said person unassociated with said item at the end of said game based on placement of said item.

10. The betting game of claim 9, wherein, at the end of the game, items are ranked by a total of placed bets on each item, and pay-outs are made to players of said game based on placement order of each tangible item of said plurality of tangible items, wherein pay-outs are made for at least first and second place; and
for purposes of making a pay-out to players based on said total bets, said bets made by a person unassociated with said item are uncounted and in a separate pay-out calculation from unassociated bets.

11. A method of administering a betting game, comprising the steps of:
designating a plurality of tangible items for betting on in said betting game, wherein each item of said plurality of tangible items is associated with a player of said betting game;
starting a timer running from the start of said betting game to an end of said betting game;
receiving via a receiving device at least one bet for each item while said timer is running;
updating exhibition of total received bets for each item at time intervals while said timer is running, said exhibited total of received bets for each item being for a previous time during said betting game.

12. The method of claim 11, wherein said previous time is a fixed amount of time prior to a time when said display device is updated at each regular time interval of said regular time intervals.

13. The method of claim 11, wherein more than one tangible item is associated with said player of said betting game, and said bet receiving device receives at least one bet for each said more than one tangible item.

14. The method of claim 12, comprising the following additional steps:
determining that said game has ended;
ranking items based on total placed bets on each item; and
making pay-outs to players of said game based on placement order of each tangible item of said plurality of tangible items, wherein pay-outs are made for at least first and second place.

15. The method of claim 14, further comprising a step of adding a starting funding amount before said start of said game, said starting funding amount to be counted towards total of placed bets.

16. The method of claim 14, wherein said pay-out is diminished by a percentage retained by an administrator of said betting game after said end of said game.

17. The method of claim 14, wherein pay-out percentages are designed such that a player winning first place loses money when betting a threshold amount over a player winning second place.

18. The method of claim 17, wherein said first place pay-out is 50% of said total placed bets, said second place payout is 30% of said total placed bets, and said third place payout is 20% of said total placed bets.

19. The method of claim 11, further comprising a step of:
receiving a bet for a said tangible item of said plurality of items from a person unassociated with said item; and
paying out winnings for said bet from said person unassociated with said item at the end of said game based on placement of said item.

20. The method of claim 19, further comprising steps of:
determining that said game has ended;
ranking items based on total placed bets on each item; and
making pay-outs to players of said game based on placement order of each tangible item of said plurality of tangible items, wherein pay-outs are made for at least first and second place; wherein for purposes of making a pay-out to players based on said total bets, said bets made by a person unassociated with said item are uncounted and in a separate pay-out calculation from said unassociated bets.

21. The method of claim 11, wherein said time interval between updates of said display becomes shorter as said game progresses.

22. The method of claim 11, wherein, at each said updating of said total received bets for a said previous time, a length of time between said previous time and a time of each said update decreases as said game progresses in time, such that each time said display is updated there is decreasingly less lag.

23. The method of claim 17, wherein said payout percentage for said received bets is varied based on the closeness of the total amount bet for said first and said second place tangible items.

24. The method of claim 22, wherein said decreasingly less lag at a last said updating is near-zero lag.
